(19) United States
(12) Patent Application Publication
(10) Pub. No.: US 2013/0325660 A1
(43) Pub. Date: Dec. 5, 2013

(54) SYSTEMS AND METHODS FOR RANKING ENTITIES BASED ON AGGREGATED WEB-BASED CONTENT

(71) Applicant: AUTO 100 MEDIA, INC., Santa Monica, CA (US)

(72) Inventor: Sue Callaway, Santa Monica, CA (US)

(73) Assignee: Auto 100 Media, Inc., Santa Monica, CA (US)

(21) Appl. No.: 13/830,979

(22) Filed: Mar. 14, 2013

Related U.S. Application Data
(60) Provisional application No. 61/653,323, filed on May 30, 2012.

(51) Int. Cl. G06Q 30/06

(52) U.S. Cl. CPC G06Q 30/0609
USPC 705/26.35

(57) ABSTRACT

Disclosed here are methods, systems, paradigms and structures for ranking entities associated with any given industry. The systems and methods include performing a combination of semantic, citation and numerical analysis to produce a raw measure of each entity's influence/interest that is predictive of financial market movement, consumer demand, consumer-based web chatter and other metrics. The systems and methods further include utilizing the raw measures of influence/interest into a consumer-facing ranking of entities pertaining to a given industry.

### PRIORITY CLAIM

This application claims the benefit of U.S. Provisional Application Ser. No. 61/653,323, filed May 30, 2012, all of which is incorporated herein by references for all purposes in its entirety.

### FIELD

Various embodiments of the present invention generally relate to ranking entities in an industry based on aggregated web-content related to the ranked entities and determining the interconnected relationship between the disparate entities in the industry as a whole.

### BACKGROUND

Today, entities in various fields are ranked according to a range of parameters, providing consumers a quick tool to evaluate the various entities and the related services offered by them. For example, in automotive rankings related to new cars, the rankings are mostly based on parameters such as sales figures of the ranked cars, their sale price, features, incentives, etc. Similarly, automotive ranking related to used cars, the rankings are mostly based on parameters such as resale value of the ranked cars, their reliability, features, etc.

However, there exists no true ranking system that brings together rankings of disparate entities in an industry ecosystem, such as ranking of new and used cars, rankings based on automobile manufacturers' perceived reputation, etc., generating a truly representative ranking based on cumulative insight into the interconnected relationship between the disparate entities across the industry ecosystem. Further, there exists no ranking system that truly reflects real-time market interest in their ranking of various entities. Such a ranking based on the cumulative insight reflecting real-time market interest would help consumers cut across categories of rankings within an industry ecosystem and identify products and services that carry the best perceived consumer value.

### SUMMARY OF THE DESCRIPTION

Disclosed herein are systems and methods that perform a combination of semantic, citation and numerical analysis to produce a raw measure of a given entity influence/interest that is predictive of financial market movement, consumer demand, consumer-based web chatter and other metrics. The systems and methods further utilize the raw measures of influence/interest into a consumer-facing ranking of entities pertaining to a given industry. In embodiments, a ranking generation system includes several components, including a data-gathering sub-system for crawling information from various web-sources and identifying mentions of entities relevant to a given industry; a data analysis-subsystem to analyze parsed information from the crawls to determine context, weight, sentiment, and other factors related to determining an indication of the presence of the entity in the web; and a ranking subsystem to determine a raw score of aggregated mentions and from the raw score to determine deviations of scores from a consistently moving average of raw scores. The ranking system, in embodiments, presents ranking of vertical dimensions of each entity type within the industry, and in embodiments provides an overall ranking of all mentions within the industry that accounts for all vertical dimensions. In embodiments, the overall consolidation of the ranking and data-reporting enables identification among entities and identifying new connections, and also facilitates provision of information pertaining to strength of entity relationships.

This Summary is provided to introduce a selection of concepts in a simplified form that are further described in the Detailed Description and drawings. This Summary is not intended to identify essential features of the claimed subject matter or to limit the scope of the claimed subject matter.

### BRIEF DESCRIPTION OF THE DRAWINGS

The techniques introduced here may be better understood by referring to the following Detailed Description in conjunction with the accompanying drawings, in which like reference numerals indicate identical or functionally similar elements:

FIG. 1 provides an illustrative representation of entities and the use of entities in the ranking system employed herein;

FIG. 2 provides an illustration of a hierarchical representation of entities with the top-level primary entities and further hierarchy levels for child entities in the context of the auto-industry;

FIG. 3 provides an illustrative flow of a process used, for example, for vertical ranking of constituent entities under a given dimension;

FIG. 4 provides one exemplary illustration, in the form of a flow diagram, for the calculation of raw weighted scores for each entity within the automotive industry ecosystem;

FIG. 5 is a flow diagram that illustrates an example of a process for providing an aggregated ranking;

FIG. 6 shows an example of a scatter diagram where the X-axis indicates sentiment and the Y-axis indicates movement in ranking (as indicated by the normalized deviation scores); and

FIG. 7 is a high-level block diagram showing an example of the architecture for a computer system.

### DETAILED DESCRIPTION

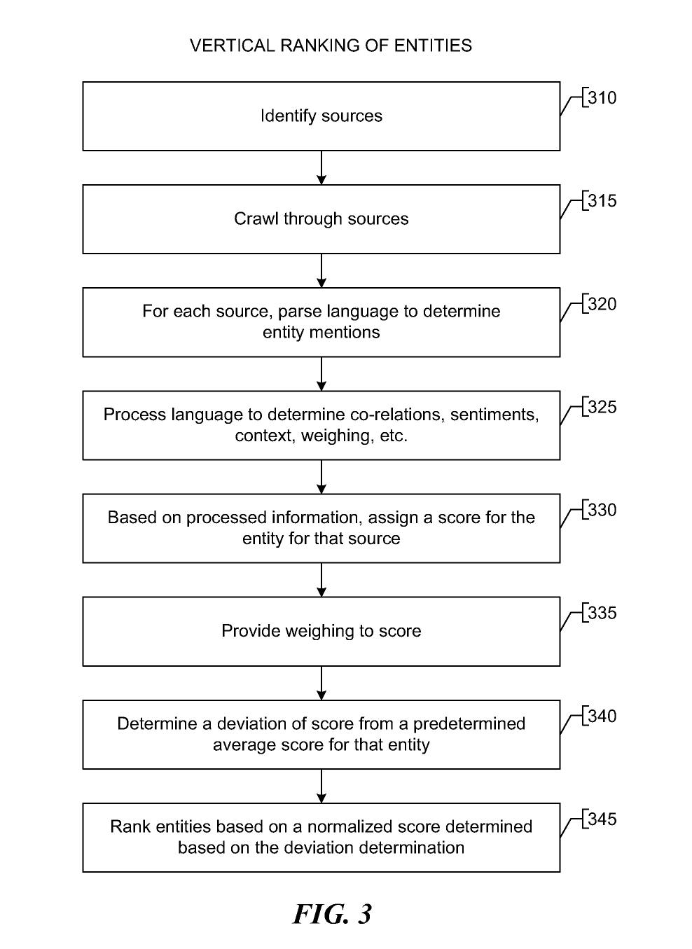

Described herein are methods and systems for using content aggregated from various web sources to efficiently rank and otherwise consolidate information related to entities pertinent to an industry. The ranking system introduced herein comprises at least the following subsystems: a data gathering sub-system to obtain data about the entities from various web-sources; a data analysis sub-system to process the data and determine various scoring analytics based on the gathered data; and a ranking subsystem that provides various user-configurable ranking options to rank the entities based on various criteria. The operations of these sub-systems are further discussed in detail with the aid of FIGS. 3-6 of this Specification. Before a discussion of these sub-systems, it is instructive to define the term “entity,” as is defined in the Specification.

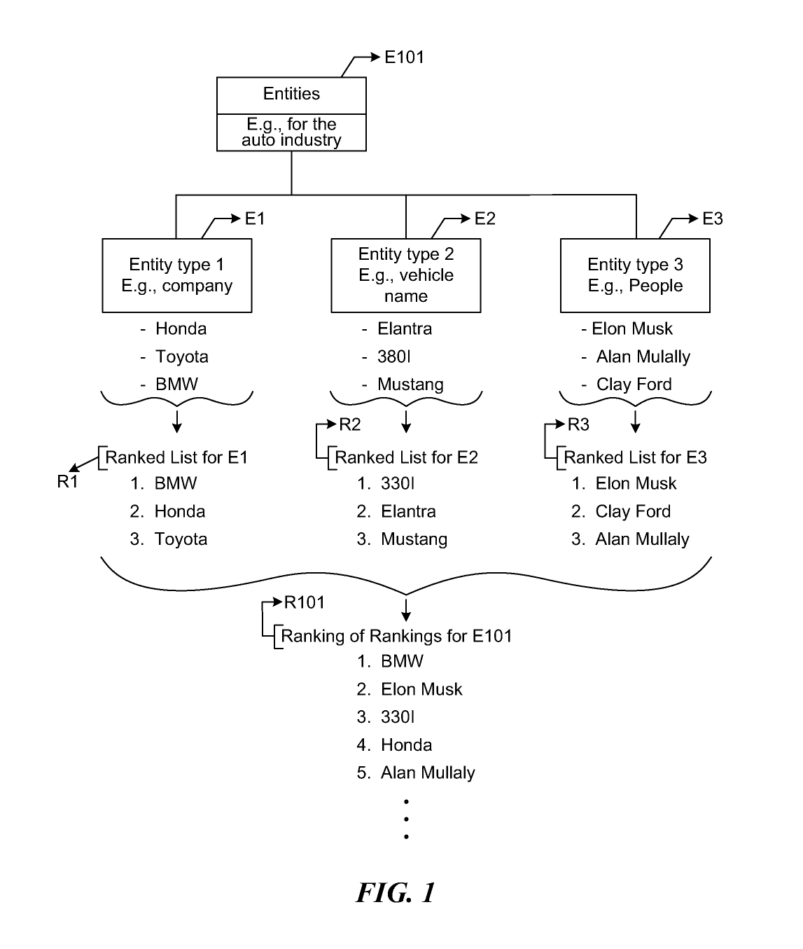

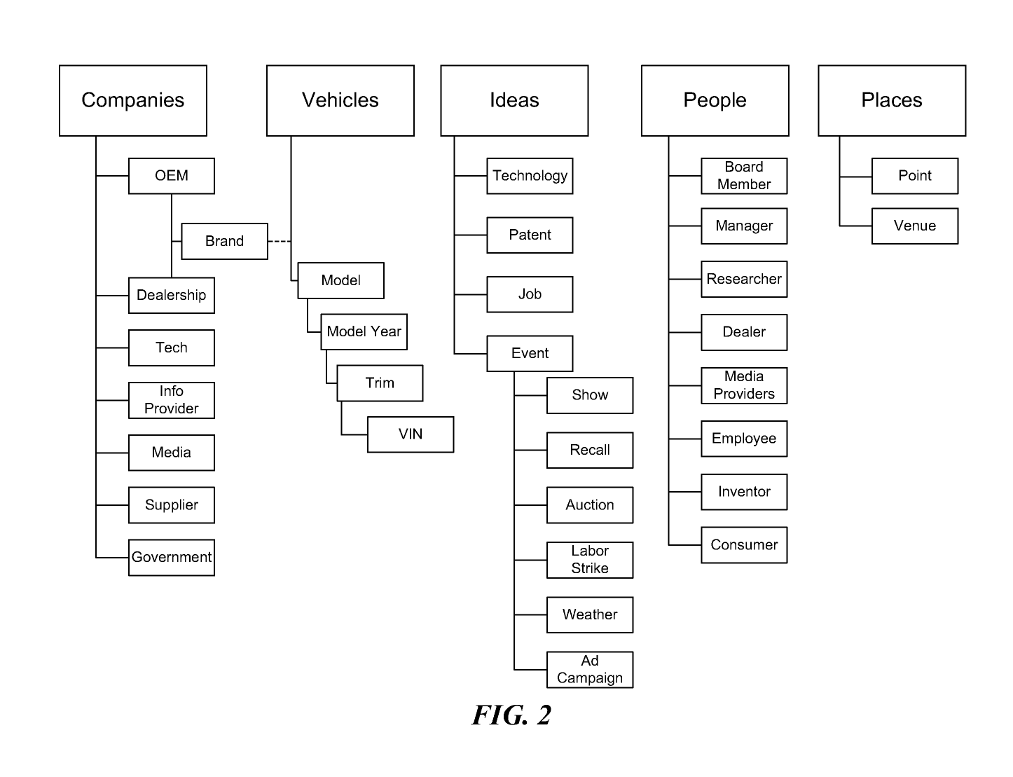

An entity, as used herein, could refer to any parameter of interest relevant to an industry. As an example, in relevance to the auto industry, entities (or entity types, or dimensions as may be alternatively referred to herein) could be any person, vehicle, company, organization, event, job, technology, patent, or place associated with the auto industry. It is understood that entity, as is relevant to an industry, could be a non-exhaustive list of similar factors of interest for that industry and could include any such factor as may be contemplated by a person of ordinary skill in that technology or industry. While the auto industry may be utilized here for explanation of various systems and processes herein, it is understood that the same fundamental principles and operations may be applied to any industry (e.g., medical industry with doctors, hospitals, procedures, pharmaceutical companies, etc. as entities; education industry with colleges, professors, high schools, government agencies, etc. as entities; etc.) as may be contemplated by a person of ordinary skill in the art. FIGS. 1 and 2, further discussed in detail below, provide further illustrative examples of entities.

FIG. 1 provides an illustrative representation of entities and the use of entities in the ranking system employed herein. The ranking system, as applied to an exemplary industry (e.g., the auto industry) comprises one or more entities E101 that are pertinent to the industry. Such entities or entity types may include a company entity E1, a vehicle name entity E2, people entity E3, etc. Various company names (e.g., Ford, Honda, BMW, etc) in the industry, as are identified and tracked from various industry sources, would fall under the company name entity E1. Similarly, vehicle names (e.g., Honda Civic, Elantra, etc.) would fall under E2 and people associated with the industry (e.g., Elon Musk as the CEO of Tesla, etc.) would fall under E3. These identified entities, as will be discussed in more detail below, are either new entities discovered using semantic and other analysis of various web feeds or sources or could relate to tracking of previously known entities.

Subsequent to the initial ranking processes (that will be discussed below), the constituents under each entity are scored and ranked relative to each other within the same entity type. Such ranking examples are illustrated in R1, R2, and R3. For example, in R1, the various company names are ranked, for example, as an indication of their web presence in the last week. In some instances, these individual entity type rankings are further consolidated based on a “ranking of rankings,” that consolidates rankings for the various entity types selected for representation in the industry. In the illustration shown in FIG. 1, E101 is the ranking of rankings that accounts for individual and comparative scoring of each of the constituents of the various entities and entity types and prepares a consolidated ranking. As will also be explained, the consolidated ranking will account for correlations and interaction between the various constituent entities based on the manner in which they are related or represented in the original source feeds.

FIG. 1 provided a quick and simple illustration of entity types and entity constituents. Of course, it is envisioned that each entity or entity type may have several child entities under which the various constituents may fall under. In some instances, the child constituents may be considered separate entities for the purpose of ranking in the vertical and consolidated ranking systems. It is understood that in at least some embodiments it does not matter how the entity constituents fall under the child hierarchy levels—they are still scored and ranked according to the process described in detail herein, either vertically based on their child entity level or the parent entity level. FIG. 2 now represents an illustration of a hierarchical representation of entities—with the top-level primary entities and further hierarchy levels for child entities in the context again of the auto-industry.

The primary entities, or dimensions, herein include the examples of companies, vehicles, ideas, people, and places. So, when vertical ranking is drawn, in at least one embodiment, all constituent entities falling under a particular dimension are grouped together for ranking purposed. It is envisioned that this concept may further extend, in some embodiments, to the child entities to allow vertical ranking systems to be in place from the perspective of one of the child entities such that all entities falling under that child entity (e.g., an OEM) is incorporated for further ranking. A dimension-level ranking of rankings could then incorporate ranking of the various child-level vertical rankings in a manner similar to the ranking of rankings addressed further below. Other distinct dimensions included in FIG. 2 include “ideas” which accounts for mentions based on patents and other technology driven considerations, thus giving the ranking and scoring systems a more well-rounded purview of information about the entities, in contrast to prior art systems that may restrict information feeding to blogs and news articles. FIG. 2 also illustrates the cross-correlation of various dimensions or child entities under the dimensions. For example, a “brand” child entity may be representative of both the company and the vehicle model, so weightages and allocation of credit for mentions under such correlations are adjusted in an intelligent manner, as is also discussed in detail further below.

FIG. 3 now provides an illustrative flow of a process used, for example, for vertical ranking of constituent entities under a dimension. It is understood that the process illustrated here is represented in a particular flow, but does not necessarily indicate a requirement of a particular order or sequence in the manner of operations. It is further understood that each of the steps described herein are implemented in hardware and are executed by operation of a processor, and may constitute sub-systems that are enabled in firmware, software, or hardware (e.g., using ASIC elements) as may be contemplated by a person of ordinary skill in the art.

As is illustrated in FIG. 3, the process starts at step 310 with identification or cognizance of various sources from which information about the entities can be gleaned. There are wide variety of sources to obtain such information from, and while a bulk of the source types may remain common across various industries, some industries (such as the auto industry illustrated as an example here) may use specific sources (e.g., auto safety board reports, etc.). The content to be parsed may be gleaned in the form of content feeds (e.g., Yahoo auto reviews), social media feeds (e.g., mentions in Twitter or in social blog sites), and other such data feeds. They may be collected or connected with in the form of RSS protocol calls and RSS feeds, remote procedure calls for obtaining feeds over remote calls, simple webpage traversal, dumps from various web sites, or just about any method that may be understood by a person of ordinary skill in the art for obtaining such information. Subsequent to identifying such sources, the ranking system, as is depicted in step 315, crawls through the information sources to parse and extract information about the occurrence of identities (or, as is used herein, “mentions” of the entities or entity constituents). Some illustrative examples of categories or sources of such content and the type of information that is crawled are listed below:
Citation/News: Crawlers search specific websites (sometimes specific sections) for indexed pages referencing ranked entities
Content—Crawlers subscribe to and search content feeds
Social Data—Crawlers search social media posts on ranked entities
Job Boards—Crawler search job boards for opportunities in the automotive sector (including openings in companies that support the industry)
Financial/Economic Data—Crawlers search financial data of publically traded companies in the automotive sector
Innovation Data—Crawlers collecting patent and general IP data are run once a month. The crawlers extract the patent, and the inventors, as well as companies associated with patents, patent applications, trademarks, copyrights or such

As is illustrated in step 320, the ranking system enables crawlers to parse through the vast corpus of information to identify mentions of the entities or entity constituents. This identification may involve several aspects. In one example, the crawlers (using crawl spiders) may parse the information for words or phrases that are associated with pre-existing or pre-identified entity constituents. The spiders crawl the web and search for entities within the automotive ecosystem. When an entity is found, each sentence in the entity's citation for parsing and eventual determination of positive and negative sentiment. In embodiments, The crawlers additionally capture, for example, source Link (for the purpose of content aggregation), writer/author/poster information, associated photos and content from the link, etc. for further inclusion in conjunction with ranking reports presented to a user.

For example, when a source being crawled directly mentions the entity constituent “Ford Motors,” the mention is accounted for and the associated information is accounted for further processing. In some instances, the entity constituent may be determined based on semantic analysis or relational analysis. For example, instead of mentioning the constituent by name, the source may mention something related to the constituent name. For example, consider the source stating something to the effect of “President Obama presents medal of innovation to Elon Musk for hybrid care technologies.” Here, there may be two constituent entities—One directly to the name of the person, namely the CEO of Tesla Motors. However, in some embodiments, because the system is aware (based, e.g., on semantic and natural language processing analysis of the phrase to determine relational associations) that it is more so the company (Tesla Motors) that deserves credit for the mention. Accordingly, in this instance, Tesla Motors may also be provided credit for this mention. As will be discussed in later sections, the system may either award two separate points for each mention or may split the point scores on some relational basis between the two entities. In general, in some embodiments, the crawler breaks down the story/citation into sentences and each sentence is treated as its own data set. This allows the algorithm to identify and focus on the entity/entities being cited in the sentence.

Such parsing may not be limited to a particular type or category of information, and may also include parsing relevant to the particular type of industry. Generally, the following are examples of information parsing techniques employed by the parser sub-system, as may be observed (in an illustrative manner) from the perspective of the auto industry:
Features—These are features of a vehicle, person, company or technology that will be used to auto-generate background information about entities for detail pages. This parsing process is also used to specify any related entities (e.g. a designer's association with a vehicle or product).
Technologies—Any technology that is used to enhance a car and has widespread industry ramifications. For instance, a turbo-charging technology might apply to multiple vehicles, be associated with a company, or stand alone as a separate ranked entity.
Places—The specific location where a relevant entity is based (company, job, etc.) or where an industry event is held
Events—Key industry events related to transactions, production, or display of automotive-related entities
Relationships—The way in which any two primary entities are connected. For example, a “Ford Mustang model is a product of the Ford brand”, “Concours d'Elegance is held at Pebble Beach”

Subsequent to the crawling and the associated identification of the mentions, as is indicated in step 325, additional information is determined for, for example, the purpose of determining sentiment of the mention. Natural language processing means may be employed, for example, to determine whether a particular mention of an entity is in positive light or in negative light (such that scoring can be adjusted accordingly for the mention). It is understood that any mechanism available and known to a person of ordinary skill in the art for determining sentiment and context from a parsed phrase is contemplated as provided teaching for the sentiment analysis portion of this disclosure. For example, if a phrase mentions something to the effect of “Ford Elantra delivery delayed due to failure of safety compliance tests,” the mention of Elantra and possibly Ford are both recorded, but with associated indication that it was in negative light. As will be discussed further in this description, scoring or credit for the mention is adjusted accordingly.

Subsequently, as indicated in step 330, the entity mentions are used to determine scoring for the entities. In one embodiment, an entire web source (regardless of the number of mentions within the web source) may be assigned a single point value as an indication of that web source. In other embodiments, each distinct mention may be given an associated score. A combination of such scorings, or a distribution of any other kind as may be contemplated by a person of ordinary skill in the art, may also be substituted or used herein. In embodiments, as was mentioned above, the mentions may be relationally scored based on a single data set including multiple connected or relational entities (e.g., Elon Musk wins award for Tesla Motors). In some instances, the score point (e.g., a single point) may be equally shared between the entities, or both entities may be given full score (in a way, allowing for double counting) when the context validates the substantial nature of both mentions, or may allocate a percentage value based on the relative importance or significance of each mention within the data set. Again, the concept of relational accounting within a dataset if of import here, but the manner in which the scoring is shared or assigned may be of any methodology as may be conceivable to a person of ordinary skill in the art.

Additionally, in embodiments, the scoring is either negative or positive based on the perceived sentiment value. Accordingly, if Tesla Motors has a total of 10,000 mentions from 2000 different web sources, and 8,000 are positive sentiments and 2,000 are negative sentiments, then the ranking system may choose to accommodate one or more of the following as the resultant score (assuming a point of 1 for each mention): 6,000 overall points by subtracting negative mentions from positive mentions, or 8000 overall points for only the positive mentions, or 10,000 overall points for any type of mention. Of course, it is conceivable that a user of the system can selectively configure the scoring to be adapted to a particular task at hand, and in embodiments, the scoring process may dynamically be able to account for such inputs.

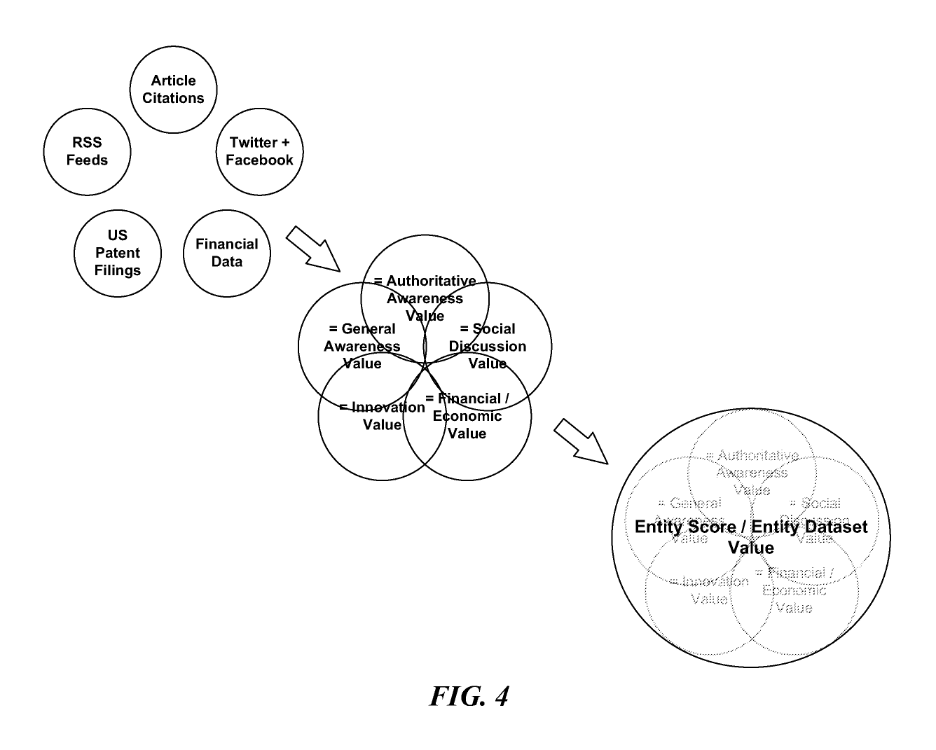

Further, as indicated in step 335, the mentions from a particular web source may be weighted based on the quality and reputation of the particular web source. For example, a mention in NY Times may get a weighting multiplier of 1, but a blog article with fewer than 100 subscribers may get a weighting multiplier of 0.2. Again, in embodiments, it is conceivable that a user may be able to provide these multipliers and weighting options in a dynamic basis, and the other examples are provided purely for the purpose of illustration. At this point, the raw scores of the mentions for the entities are computed and are ready for presentation or further processing. Further information on how the raw scores are computed from mentions aggregated from various sources is illustrated in reference to FIG. 4 below.

It is understood that the raw scores at this point includes mentions that are aggregated over a fixed period of time. For example, it may be for sources crawled in the last week or the last day or the last hour or may be at any granularity indicated by the user. A ranking of the scores may be provided, in some embodiments, using the raw weighted scores. However, this may pose to be a disadvantage when comparing large companies to small companies in the industry. Just by virtue of their large corporate presence, large companies may get tremendous numbers of mentions while small companies may not have as many mentions but may still be significant.

To counter this imbalance, the ranking system proposed herein accounts for deviations of the number of mentions (indicated in the form of the weighted raw score) relative to an average number of mentions (indicated as an average of the weighted raw scores) for that entity over a prior period of time. For example, in embodiments, a user would be able to define the time window of the prior period of time to account for the average or the system may by default indicate a value (e.g., 4 weeks). In this example, the deviation score would be computed as a function of the ratio (or inverse ratio) of the 4-week average weighted raw score vs. the current weighted raw score. Doing this allows all companies, regardless of size to be represented at an even keel, and allows for any jumps or drops in relative mentions to be immediately noticed in a graphical representation of the various rankings considered at the same scale level. Such a 4-week (or an average of another scale) simple moving average establishes a baseline for each entity, smoothens out irregularities, captures trends, and put all entities on a common scale regardless of their size (e.g. Ford vs. a small part manufacturer).

In some embodiments, the resultant deviant scores are normalized, for example, on a scale of 0-1 (or in some cases, −1 to 1), which is then indicative of the extent of spike or fall in mentions of the entity in relation to its average over a period of time. In this manner, all entities within a dimension of the industry are scored and then ranked according to the normalized deviation scores. Accordingly, entities within an industry are ranked and web-based content is concurrently aggregated and curated to support the movement of an entity within an industry. Unlike other prior-art sites, one of the features of novelty here is that it is not just “new information” that is ranked, rather the content that reflects real-time interest.

FIG. 4 provides one exemplary illustration, in the form of a flow diagram, for the calculation of raw weighted scores for each entity within an automotive industry ecosystem. As is depicted in Step A, spiders crawl the websites and search for entities within the automotive ecosystem. When an entity is found, the article is captured and then scrubbed to single out the citations within sentences. Each sentence is then parsed and examined for entity scoring. Positive and negative sentiment analysis is performed: for each positive mention, the cited entity is given a point. For each negative mention, the entity loses a point.

As is depicted in Step B, after every sentence has been parsed, a combined score is saved for entities in a citation. This creates individual “VALUE” score for various citation types. These “TYPES,” as used in this exemplary illustration are: citation value (e.g., editorial citations from leading publications), RSS Value (RSS Feeds), social value (e.g., Facebook & Twitter), vision value (e.g., patents), and market value (e.g., financials). Additionally, each type of value can be individually weighted within the algorithm. As indicated in Step C, a final entity score is determined by adding together the individual value scores from each feed. In some instances, as was indicated above, once the scoring is done, an entity is defined as a dataset value. Each dataset value has a basic inferred relationship with other dataset values. For example, a person is related to a technology, as the technology is related to a product, as a product is related to a company.

The previous sections discussed determining scores for mentions of entities in various sources and grouping the entities within a vertical dimension (i.e., within a particular type of entity). The proposed ranking mechanism disclosed herein further contemplates a ranking of rankings that allows multiple vertical dimensions to be aggregated and presented as a joint ranking of vertical dimensions. In one embodiment, all vertical entity dimensions for a particular industry may be presented together in an aggregated ranking that accounts for all information tracking within the industry. Further, as is discussed below, consolidating the vertical dimensions allows a user to identify and appreciate the connections between the various entities of the organization, allowing a more rounded approach of presenting the information.

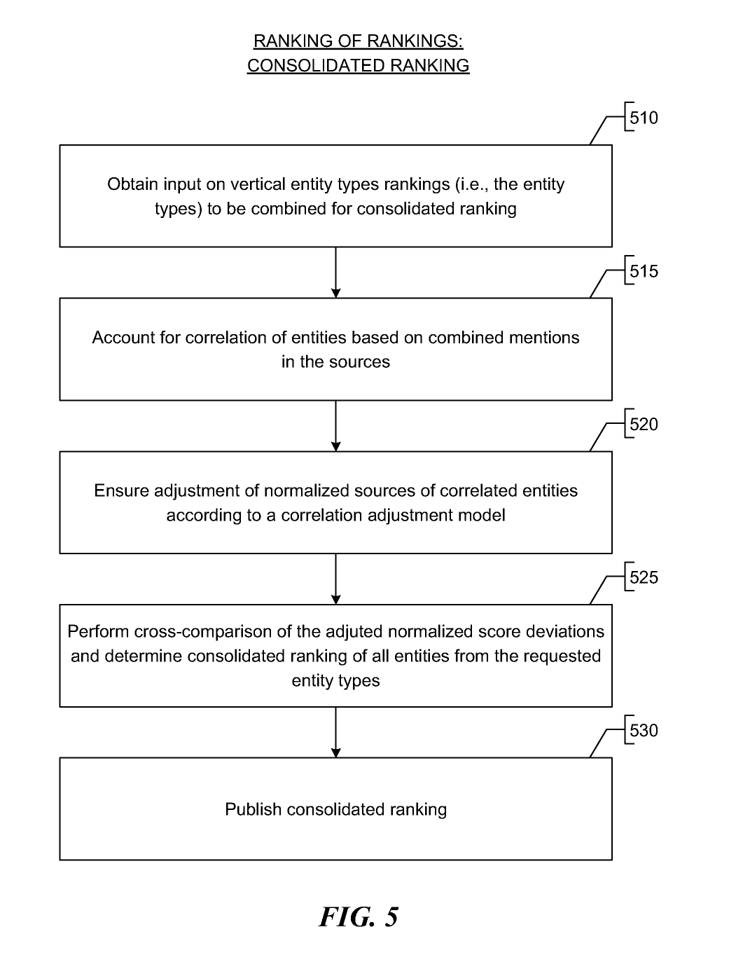

FIG. 5 is a flow diagram that illustrates an example of a process for providing such an aggregated ranking. The process starts at 510 with obtaining an input on the different vertical dimensions to be considered for the aggregated ranking. In some embodiments, this is an automatic step that accounts for all the vertical dimensions previously identified for or accounted for the particular industry. In some embodiments, it is conceivable that a user could be presented a choice of providing specific dimensions he would like aggregated for the ranking, allowing customized dynamic viewing of aggregated rankings.

Step 515 follows, and is not necessarily inherent at this stage in the aggregated ranking progress. As previously mentioned in relation to the parsing and scoring sections, some phrases or data sets obtained from the net have multiple entities (or entities from different vertical dimensions) being mentioned and corresponding relationships among such entities. In some embodiments, such relationships are already accounted for on the basis of score-sharing, or double-counting, or other such methodologies. In some embodiments, where the relationships are not accounted for in scoring (e.g., where both the company and the CEO get individual credit within their vertical dimensions despite being mentioned in the same message or phrase), the ranking system does a re-adjusting of scores at this stage (i.e., when aggregated ranking needs to be determined) to reflect proper accounting of the relationships.

In some examples, as noted in step 520, a correlation adjustment model may be used to readjust the scoring. The adjusted score may be the raw weighted data set score for the entity or may be the normalized deviation score, based on the circumstance or the preference of the user, but the end result would be similar in either situation. In embodiments, the correlation adjustment model may use one or more of several parameters to adjust the allocation or distribution of scoring among commonly mentioned entities. Examples of such distribution were provided above (e.g., either double counting based on import of phrase containing multiple mentions, divide score as a percentage to the amount of import of the individual entity mentions in relation to the subject or context of article, divide the score substantially equally among the mentioned entities, etc.).

Subsequently, at step 525, the ranking system performs an aggregated ranking of the various scores. In embodiments, the ranking system cross-compares the normalized deviation scores (i.e., an indication of increase in popularity) of an entity from a first vertical dimension to a similar ranked entity in a second dimension and ranks the two based on comparison of their respective changes in deviation from their period-averages. In the context of the auto industry example above, the “pure” rankings or the aggregated rankings of the people, vehicles, technologies, companies, and other such entity dimensions are ranked against one another via the ranking score within their category (i.e. movement up and down and the severity of that movement).

In an example, if an entity, such as a person, is No. 10 in his/her category, they are compared to the vehicle, company, and technology ranked No. 10 in each respective category. If a vehicle is positioned stronger based on percentage of points accumulated compared with percentage of movement to another entity, the vehicle will receive a better ranking in the aggregated ranking scale. This consolidated ranking or aggregated ranking is then published to the user as a ranking of the entire industry (across all tracked vertical dimensions), as is illustrated in step 530.

Consolidation of the scores and the rankings (or consolidation of the vertical entity dimensions in general) provides additional ancillary benefits, as is discussed in this section. For one, new data sets and intersections are able to be generated based on the interactions in the consolidated database. New connections are created between ranked entities and new datasets are created and areas of inference or overlap become apparent. Consequently, the aggregated ranking system generates a cumulative insight into the interconnected relationships in the industry as a whole. For example, the aggregated ranking system provides insight into how the people listed for an entity overlap with one or more companies of that industry, thus giving an insight into the amount of influence a person has had to the industry in general, as tracked from recent mentions.

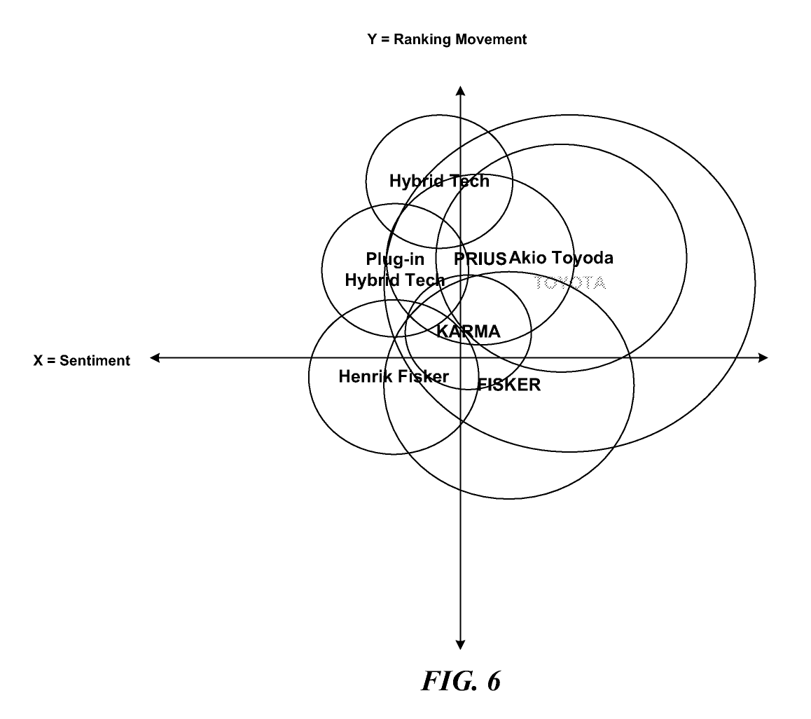

Further, another ancillary advantage is the ability to strength of entity relationships. For example, an entity company score might have an entity technology that is ⅓ the size of its parent (size being determined by citation value as indicated by normalized deviation scores). In embodiments, this can be illustrated using scatter diagrams, an example of which is depicted in FIG. 6. FIG. 6 shows an example of a scatter diagram where the X-axis indicates sentiment and the Y-axis indicates movement in ranking (as indicated by the normalized deviation scores). In the context, for example, where child verticals are integrated into one ranking or multiple vertical dimensions are integrated into one ranking, the aggregated ranking helps provide a quantitative interest of a specific child entity (or one of the entity verticals) in a corresponding parent entity or the overall industry entity.

In embodiments, the scatter diagram also represents quantitative entity data values, using citation analysis from professional media sources (e.g., “Authoritative Awareness Value”) along with other source values (e.g., social discussion value) that can be used to measure the qualitative relationships between entities. In an illustrative example, such relationship connectors provide considerable insight into brand consciousness and identify marketing and other business strategies. In one example, where the child entity “hybrid system” has an enormous impact (in terms of percentage of coverage) on the parent entity (e.g., Toyota company) such that the two are nearly synonymous, this immediately reinforces the need for Toyota to continue investing and strategizing around using hybrid technology at least as a brand statement.

The following section provides an example of computing strength of such relationship values. However, many times separate entities share the points that make up their score within the database. When a company and its product, or a product and an individual are mentioned in the same citation, they connected by the citation. For example, if a vehicle like the Chevrolet Volt is mentioned 3 times in one article, and Robert Lutz (Vice Chairman of General Motors) is mentioned 5 times the same article, the Volt and Robert Lutz share (1−r)×3 points where r is the number of times that the two entities have been mentioned in past content for the last 6 months. These shared points are the basis for defining the strength of relationships between entities. In a more illustrative example, an Entity Person might receive 10,000 citation points and an Entity Product might receive 5,000 points as weighted score values. If the two entities share 2,000 points total, the relationship can be defined as 20% of the Entity Person and/or 40% of the Entity Product. This can be expressed as: Relationship Value of Entity Person to Entity Product is >Relationship Value of Entity Product to Entity Person. Or: Relationship Value of Entity Product to Entity Person is <Relationship Value of Entity Person to Entity Product.

Accordingly, as described herein, entity relationship values use quantitative datasets to understand the qualitative relationships between disparate entities. Such a relationship can be expressed in user interfaces via, for example, basic pie charts, Venn diagrams, Euler diagrams, scatter plots controlled by database filters using MySQL queries, etc. Additionally, these relationships can be modeled in multiple dimensions using timeline and historical Ranking analysis from the ranking systems disclosed herein.

The foregoing description of the embodiments of the invention has been presented for the purpose of illustration; it is not intended to be exhaustive or to limit the invention to the precise forms disclosed. Persons skilled in the relevant art can appreciate that many modifications and variations are possible in light of the above disclosure.

Some portions of this description describe the embodiments of the invention in terms of algorithms and symbolic representations of operations on information. These algorithmic descriptions and representations are commonly used by those skilled in the data processing arts to convey the substance of their work effectively to others skilled in the art. These operations, while described functionally, computationally, or logically, are understood to be implemented by computer programs or equivalent electrical circuits, microcode, or the like. Furthermore, it has also proven convenient at times, to refer to these arrangements of operations as modules, without loss of generality. The described operations and their associated modules may be embodied in software, firmware, hardware, or any combinations thereof.

Any of the steps, operations, or processes described herein may be performed or implemented with one or more hardware or software modules, alone or in combination with other devices. In one embodiment, a software module is implemented with a computer program product comprising a computer-readable medium containing computer program code, which can be executed by a computer processor for performing any or all of the steps, operations, or processes described.

Embodiments of the invention may also relate to an apparatus for performing the operations herein. This apparatus may be specially constructed for the required purposes, and/or it may comprise a general-purpose computing device selectively activated or reconfigured by a computer program stored in the computer. Such a computer program may be stored in a tangible computer readable storage medium or any type of media suitable for storing electronic instructions, and coupled to a computer system bus. Furthermore, any computing systems referred to in the specification may include a single processor or may be architectures employing multiple processor designs for increased computing capability.

Embodiments of the invention may also relate to a computer data signal embodied in a carrier wave, where the computer data signal includes any embodiment of a computer program product or other data combination described herein. The computer data signal is a product that is presented in a tangible medium or carrier wave and modulated or otherwise encoded in the carrier wave, which is tangible, and transmitted according to any suitable transmission method.

Finally, the language used in the specification has been principally selected for readability and instructional purposes, and it may not have been selected to delineate or circumscribe the inventive subject matter. It is therefore intended that the scope of the invention be limited not by this detailed description, but rather by any claims that issue on an application based hereon. Accordingly, the disclosure of the embodiments of the invention is intended to be illustrative, but not limiting, of the scope of the invention, which is set forth in the following claims.

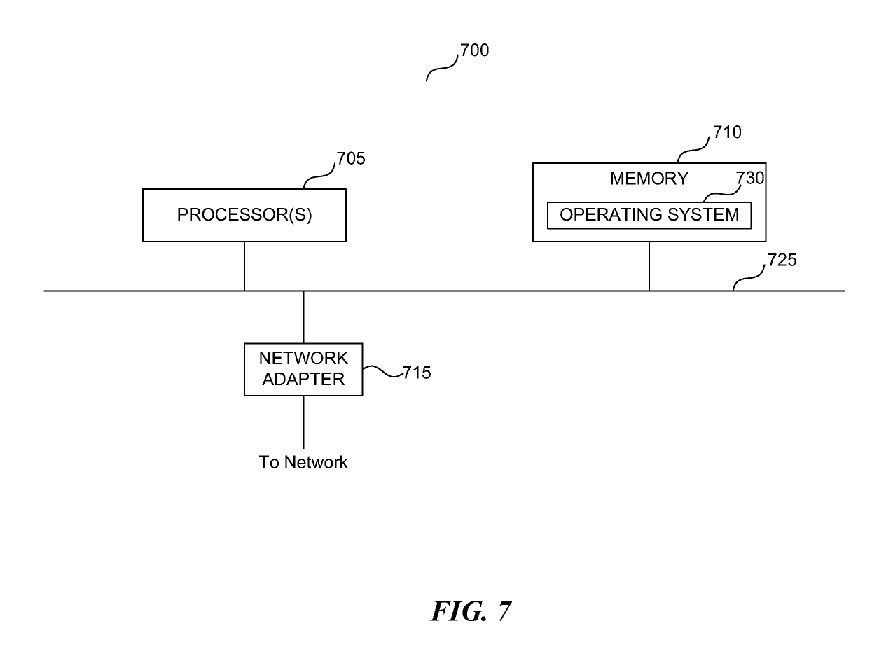

FIG. 7 is a high-level block diagram showing an example of the architecture for a computer system 700 that can be utilized to implement a ranking system, etc. In FIG. 7, the computer system 700 includes one or more processors 705 and memory 710 connected via an interconnect 725. The interconnect 725 is an abstraction that represents any one or more separate physical buses, point to point connections, or both connected by appropriate bridges, adapters, or controllers. The interconnect 725, therefore, may include, for example, a system bus, a Peripheral Component Interconnect (PCI) bus, a HyperTransport or industry standard architecture (ISA) bus, a small computer system interface (SCSI) bus, a universal serial bus (USB), IIC (I2C) bus, or an Institute of Electrical and Electronics Engineers (IEEE) standard 674 bus, sometimes referred to as “Firewire”.

The processor(s) 705 may include central processing units (CPUs) to control the overall operation of, for example, the host computer. In certain embodiments, the processor(s) 705 accomplish this by executing software or firmware stored in memory 710. The processor(s) 705 may be, or may include, one or more programmable general-purpose or special-purpose microprocessors, digital signal processors (DSPs), programmable controllers, application specific integrated circuits (ASICs), programmable logic devices (PLDs), or the like, or a combination of such devices.

The memory 710 is or includes the main memory of the computer system. The memory 710 represents any form of random access memory (RAM), read-only memory (ROM), flash memory (as discussed above), or the like, or a combination of such devices. In use, the memory 710 may contain, among other things, a set of machine instructions which, when executed by processor 705, causes the processor 705 to perform operations to implement embodiments of the present invention.

Also connected to the processor(s) 705 through the interconnect 725 is a network adapter 715. The network adapter 715 provides the computer system 700 with the ability to communicate with remote devices, such as the storage clients, and/or other storage servers, and may be, for example, an Ethernet adapter or Fiber Channel adapter.

Unless the context clearly requires otherwise, throughout the description and the claims, the words “comprise,” “comprising,” and the like are to be construed in an inclusive sense (i.e., to say, in the sense of “including, but not limited to”), as opposed to an exclusive or exhaustive sense. As used herein, the terms “connected,” “coupled,” or any variant thereof means any connection or coupling, either direct or indirect, between two or more elements. Such a coupling or connection between the elements can be physical, logical, or a combination thereof. Additionally, the words “herein,” “above,” “below,” and words of similar import, when used in this application, refer to this application as a whole and not to any particular portions of this application. Where the context permits, words in the above Detailed Description using the singular or plural number may also include the plural or singular number respectively. The word “or,” in reference to a list of two or more items, covers all of the following interpretations of the word: any of the items in the list, all of the items in the list, and any combination of the items in the list.

The above Detailed Description of examples of the invention is not intended to be exhaustive or to limit the invention to the precise form disclosed above. While specific examples for the invention are described above for illustrative purposes, various equivalent modifications are possible within the scope of the invention, as those skilled in the relevant art will recognize. While processes or blocks are presented in a given order in this application, alternative implementations may perform routines having steps performed in a different order, or employ systems having blocks in a different order. Some processes or blocks may be deleted, moved, added, subdivided, combined, and/or modified to provide alternative or sub-combinations. Also, while processes or blocks are at times shown as being performed in series, these processes or blocks may instead be performed or implemented in parallel, or may be performed at different times. Further any specific numbers noted herein are only examples. It is understood that alternative implementations may employ differing values or ranges.

The various illustrations and teachings provided herein can also be applied to systems other than the system described above. The elements and acts of the various examples described above can be combined to provide further implementations of the invention.

Any patents and applications and other references noted above, including any that may be listed in accompanying filing papers, are incorporated herein by reference. Aspects of the invention can be modified, if necessary, to employ the systems, functions, and concepts included in such references to provide further implementations of the invention.

These and other changes can be made to the invention in light of the above Detailed Description. While the above description describes certain examples of the invention, and describes the best mode contemplated, no matter how detailed the above appears in text, the invention can be practiced in many ways. Details of the system may vary considerably in its specific implementation, while still being encompassed by the invention disclosed herein. As noted above, particular terminology used when describing certain features or aspects of the invention should not be taken to imply that the terminology is being redefined herein to be restricted to any specific characteristics, features, or aspects of the invention with which that terminology is associated. In general, the terms used in the following claims should not be construed to limit the invention to the specific examples disclosed in the specification, unless the above Detailed Description section explicitly defines such terms. Accordingly, the actual scope of the invention encompasses not only the disclosed examples, but also all equivalent ways of practicing or implementing the invention under the claims.

What is claimed is:

1. A computer-implemented method for ranking entities associated with a given industry sector, the method comprising:
crawling a plurality of web sources to identify one or more mentions of a plurality of entities associated with the given industry sector;
associating each mentioned entity of the plurality of entities with a corresponding entity dimension; and
for a given entity dimension:
determining a raw score for each entity associated with the given entity dimension based at least in part on the identified one or more mentions of each entity;
for each entity, computing a deviation of the raw score from a moving raw-score average associated with the entity;
for each entity, determining a deviation score based at least in part on the computed deviation; and
ranking each entity associated with the given entity dimension according to the deviation score associated with each entity.

2. The method of claim 1, wherein the crawling of the plurality of web sources includes crawling one or more of a news feed, a content feed, a social network data feed, an online job board, an economic or financial data feed, an innovation information feed.

3. The method of claim 2, wherein crawling the innovation feed includes crawling of one or more of patent information feeds, trademark information feeds, or copyright information feeds.

4. The method of claim 1, further comprising:
for a given entity detected from a given web source of the plurality of web sources, detecting a sentiment associated with the mention of the given entity in the given web source.

5. The method of claim 4, wherein the given entity is given a credit of +1 for determining that the mention was in a positive sentiment and the given entity is given a credit of −1 or 0 for determining that the mention was in a negative sentiment.

6. The method of claim 5, further comprising:
determining a weightage to apply for the credit associated with the given entity, the weightage determined based on a reputation value associated with a web source corresponding to the given entity.

7. The method of claim 5, further comprising:
determining a combined mention of a first entity and a second entity in a given web source;
allocating credit to the first entity and the second entity, the allocating including one or more of:
distribute a full credit between the first entity and the second entity;
allocate a full credit each for the first entity and the second entity; or
allocate a full credit to the first entity and allocate no credit for the second entity.

8. The method of claim 1, further comprising:
computing a current overall raw score for each of the plurality of entities based on an accounting of a total number of credits the entity has under each score-type, the score-type including one or more of: citation value score score-value; RSS feed value; social value; vision value; or market value.

9. The method of claim 8, further comprising:
determining the current overall raw score for each entity based on a totaling of scores each entity possesses for one or more of the citation-value, the RSS feed value, the social value, the vision value, or the market value.

10. The method of claim 8, wherein the determining of the deviation score for a first entity of the plurality of entities further comprises:
determining an average of past overall raw scores associated with the first entity, the average computed based on overall raw scores determined for the first entity over a period of time prior to computing the current overall raw score; and
determining a deviation of the current overall raw score from the average of past overall raw scores over the period of time.

11. The method of claim 1, further comprising:
generate a plurality of rankings for a corresponding plurality of entity dimensions; and
generate a ranking of the rankings associated with the plurality of entity dimensions, generating the ranking of the rankings of a first entity dimension and a second entity dimension including:
comparing a first entity from a first position in a ranking of the first entity dimension to a second entity from a corresponding first position in a ranking of the second entity dimension;
determining whether the first entity should be ranked over or under the second entity based on comparison of deviation score values associated with the first and the second entities; and
repeating the comparing and the determining for remaining entities in the first and the second entities.

12. A computer-implemented method for ranking entities associated with an industry, the method including:
crawling a plurality of web sources to identify one or more mentions of a plurality of entities associated with the given industry sector;
determining a raw score for each entity based at least in part on a number of mentions of the entity in one or more of the plurality if web sources;
determining a deviation score for each entity based at least in part on a deviation of the raw score of the entity relative to an average score of the entity over a period of time; and
ranking the plurality of entities based at least in part on the deviation scores of the entities.

13. The method of claim 12, wherein the ranking of the plurality of entities further includes:
associating each mentioned entity of the plurality of entities with a corresponding entity dimension;
prior to ranking the plurality of entities, for each entity dimension, determining a ranking of entities associated with the entity dimension, the scoring of the entities within the entity dimension based on the deviation scores of the entities; and
ranking the rankings of the entity dimensions by aggregating the plurality of rankings based at least in part on the deviation scores associated with the plurality of entities.

14. The method of claim 13, wherein generating the ranking of the rankings of a first entity dimension and a second entity dimension further includes:
comparing a first entity from a first position in a ranking of the first entity dimension to a second entity from a corresponding first position in a ranking of the second entity dimension;
determining whether the first entity should be ranked over or under the second entity based on comparison of deviation score values associated with the first and the second entities; and
repeating the comparing and the determining for remaining entities in the first and the second entities.

15. The method of claim 12, wherein the crawling of the plurality of web sources includes crawling one or more of a news feed, a content feed, a social network data feed, an online job board, an economic or financial data feed, an innovation information feed.

16. The method of claim 12, further comprising:
for a given entity detected from a given web source of the plurality of web sources, detecting a sentiment associated with the mention of the given entity in the given web source.

17. The method of claim 16, wherein the given entity is given a credit of +1 for determining that the mention was in a positive sentiment and the given entity is given a credit of −1 or 0 for determining that the mention was in a negative sentiment.

18. The method of claim 17, further comprising:
determining a weightage to apply for the credit associated with the given entity, the weightage determined based on a reputation value associated with a web source corresponding to the given entity.

19. The method of claim 16, further comprising:
determining a combined mention of a first entity and a second entity in a given web source;
allocating credit to the first entity and the second entity, the allocating including one or more of:
distribute a full credit between the first entity and the second entity;
allocate a full credit each for the first entity and the second entity; or
allocate a full credit to the first entity and allocate no credit for the second entity.

20. The method of claim 12, further comprising:
computing a current overall raw score for each of the plurality of entities based on an accounting of a total number of credits the entity has under each score-type, the score-type including one or more of: citation value score score-value; RSS feed value; social value; vision value; or market value.

21. The method of claim 20, further comprising:
determining the current overall raw score for each entity based on a totaling of scores each entity possesses for one or more of the citation-value, the RSS feed value, the social value, the vision value, or the market value.

22. The method of claim 20, wherein the determining of the deviation score for a first entity of the plurality of entities further comprises:
determining an average of past overall raw scores associated with the first entity, the average computed based on overall raw scores determined for the first entity over a period of time prior to computing the current overall raw score; and
determining a deviation of the current overall raw score from the average of past overall raw scores over the period of time.

23. A ranking system comprising:
a processor;
a plurality of sub-systems including logic, which when executed by the processor cause the ranking system to perform ranking operations, the plurality of sub-systems including:
a data-gathering subsystem including logic for performing a series of operations when executed by the processor, the operations including:
crawling a plurality of web sources to identify one or more mentions of a plurality of entities associated with the given industry sector;
a data-analysis subsystem including logic for performing a series of operations when executed by the processor, the operations including:
determining a raw score for each entity based at least in part on a number of mentions of the entity in one or more of the plurality if web sources;
determining a deviation score for each entity based at least in part on a deviation of the raw score of the entity relative to an average score of the entity over a period of time; and
a ranking sub-system including logic for performing a series of operations when executed by the processor, the operations including:
ranking the plurality of entities based at least in part on the deviation scores of the entities.

24. The system of claim 23, wherein the series of operations associated with the ranking sub-system further includes:
associating each mentioned entity of the plurality of entities with a corresponding entity dimension;
prior to ranking the plurality of entities, for each entity dimension, determining a ranking of entities associated with the entity dimension, the scoring of the entities within the entity dimension based on the deviation scores of the entities; and
ranking the rankings of the entity dimensions by aggregating the plurality of rankings based at least in part on the deviation scores associated with the plurality of entities.

25. The system of claim 24, wherein generating the ranking of the rankings of a first entity dimension and a second entity dimension further includes:
comparing a first entity from a first position in a ranking of the first entity dimension to a second entity from a corresponding first position in a ranking of the second entity dimension;
determining whether the first entity should be ranked over or under the second entity based on comparison of deviation score values associated with the first and the second entities; and
repeating the comparing and the determining for remaining entities in the first and the second entities.

26. The system of claim 23, wherein the crawling of the plurality of web sources includes crawling one or more of a news feed, a content feed, a social network data feed, an online job board, an economic or financial data feed, an innovation information feed.

27. The system of claim 23, wherein the set of operations associated with the data analysis subsystem further includes:
for a given entity detected from a given web source of the plurality of web sources, detecting a sentiment associated with the mention of the given entity in the given web source.

28. The system of claim 27, wherein the given entity is given a credit of +1 for determining that the mention was in a positive sentiment and the given entity is given a credit of −1 or 0 for determining that the mention was in a negative sentiment.

29. The system of claim 28, wherein the set of operations associated with the data analysis subsystem further includes:
determining a weightage to apply for the credit associated with the given entity, the weightage determined based on a reputation value associated with a web source corresponding to the given entity.

30. The system of claim 27, wherein the set of operations associated with the data analysis subsystem further includes:
determining a combined mention of a first entity and a second entity in a given web source;
allocating credit to the first entity and the second entity, the allocating including one or more of:
distribute a full credit between the first entity and the second entity;
allocate a full credit each for the first entity and the second entity; or
allocate a full credit to the first entity and allocate no credit for the second entity.

31. The system of claim 23, wherein the set of operations associated with the data analysis subsystem further includes:
computing a current overall raw score for each of the plurality of entities based on an accounting of a total number of credits the entity has under each score-type, the score-type including one or more of: citation value score score-value; RSS feed value; social value; vision value; or market value.

32. The system of claim 31, wherein the set of operations associated with the data analysis subsystem further includes:
determining the current overall raw score for each entity based on a totaling of scores each entity possesses for one or more of the citation-value, the RSS feed value, the social value, the vision value, or the market value.

33. The system of claim 31, wherein the determining of the deviation score for a first entity of the plurality of entities further comprises:
determining an average of past overall raw scores associated with the first entity, the average computed based on overall raw scores determined for the first entity over a period of time prior to computing the current overall raw score; and
determining a deviation of the current overall raw score from the average of past overall raw scores over the period of time.
